(19) United States
(12) Patent Application Publication
(10) Pub. No.: US 2009/0006838 A1
(43) Pub. Date: Jan. 1, 2009

(54) Methods for Downloading a Digital Work Automatically Bound with Characteristics of a Portable Device

(75) Inventors: Zhi Tang, Beijing (CN); Changqiao Wang, Beijing (CN); Aixia Jia, Beijing (CN); Jing Zhou, Beijing (CN)

Correspondence Address: THE WEBB LAW FIRM, P.C., 700 KOPPERS BUILDING, 436 SEVENTH AVENUE, PITTSBURGH, PA, 15219, US

(73) Assignees: PEKING UNIVERSITY FOUNDER GROUP CO., LTD., Beijing (CN); BEIJING FOUNDER APABI TECHNOLOGY CO., LTD., Beijing (CN); PEKING UNIVERSITY, Beijing (CN)

(21) Appl. No.: 12/094,438

(22) PCT Filed: Apr. 29, 2006
(86) PCT No.: PCT/CN06/00852

§ 371 Date: May 21, 2008

(30) Foreign Application Priority Data
Nov. 22, 2005 (CN) 200510123594.6

(51) Int. Cl. H04L 9/28

(52) U.S. Cl. 713/150

(57) ABSTRACT

Disclosed is a method for downloading a digital work automatically bound with characteristics of a portable device, which refers to a technology of digital rights protection using an embodied system. The method achieves convenient and safe binding of digital works for a portable device. A storage space of the portable device stores digital contents and an executable program which is executed automatically after the portable device is connected to a network terminal. By this method, copyright-protected digital contents can be purchased or borrowed, and downloaded to the portable device.

### TECHNICAL FIELD

This invention refers to a technology of downloading digital works using an embodied system, more particularly, to a protection of copyright of digital works by automatically binding characteristics of a portable device to a digital work.

### BACKGROUND OF THE INVENTION

As the developments of information technology and Internet, more and more digital works and digital information arise. Meanwhile, due to the existence of various piracy techniques, digital works may be illegally used, imposing a big damage to owners of the works. Digital Rights Management technology is to protect interests of the owner and ensure that the use of digital works is under authorization of the relevant owners.

Furthermore, with the developments of special e-book readers, MP3 and MP4 players, personal digital assistants (PDA), intelligent cell phones and other portable devices, more and more digital works can be used in those portable devices. Therefore, the protection of copyright of digital works becomes a need when the digital works are used in these devices.

Generally, a portable device is not configured with networking function for the sake of cost-effective. A digital work should be downloaded to a computer first and then transmitted to the portable device for use. Because of the Digital Rights Management, it is very complicated to buy and download a digital work through a computer and then transmit the digital work to the portable device. Although some portable devices like intelligent cell phones or PDAs can access Internet, due to the limited resources, downloading a copyright-protected digital work is time-consuming. Moreover, the security cannot be guaranteed.

Booklocker of Sandisk Company is a kind of U-disk. The special software in Booklocker can be started up to download and read e-books after the Booklocker is connected to a PC. Although the process is very convenient, it cannot be applied to portable devices for the following reasons. Firstly, Booklocker is initially designed to be used together with a PC. Without a PC, Booklocker does not work. To the contrary, a portable device is designed to work without needing a PC. Moreover, Booklocker divides its storage unit into a secure zone for storing downloaded e-books and an open zone. The contents in the secure zone can be read and written only by this Booklocker. But, the contents stored in the secure zone are not bound by any characteristics of Booklocker. Further, the secure zone of the Booklocker can be read and written by the software of the Booklocker via a special port, the contents in the secure zone may be read and written by a PC, which may introduce security trouble.

In addition, as disclosed in International Publication WO 03/012577 “Device-related Software Installation”, an USB device is used as a mass storage device. In this case, after a USB device is connected to the PC, Windows Operating System having the Auto-run function starts up corresponding driver or the like so that the USB device can be identified for use. However, this technique is not convenient to download digital contents. Specifically, this technique needs to install a driver or the like in a PC having Auto-run function, while a portable device needs to receive data from a PC without installing any program on the PC. Moreover, due to Digital Rights Management, digital contents to be accessed need to be associated with information of a portable device. Thus, the security of the information is required. Using a USB port to transmit the information cannot meet the security requirement.

Chinese Patent Application No. 200410004751.7 entitled “hardware-compatible methods for binding digital works with hardware” filed on Mar. 3, 2004 by the same applicant and published on Jan. 5, 2005 discloses a method for binding, in which digital contents can be used legally with the hardware changing in a certain extent on the basis of the hardware configuration of the used PC in combination with the key share mechanism so as to achieve the hardware compatibility of digital rights protection. However, this method focuses on a general device and does not solve the problem of conveniently downloading and automatic binding for a portable device.

From above, there is a need to download digital works by using a portable device so that the copyright-protected digital works can be downloaded into the portable device conveniently and safely.

### SUMMARY OF THE INVENTION

To overcome the shortcomings of the prior art, the present invention is to provide a method for downloading a digital work automatically bound with information of a portable device. By using this method, a program for buying or borrowing digital works can be started up automatically on a network terminal after the portable device is connected to the network terminal through a port. Then, the digital work bound with information of the portable device can be downloaded directly into the portable device after the desired digital work is selected and clicked so as to download the digital work conveniently and safely.

To this end, the present invention provides a method for downloading a digital work automatically bound with information of a portable device, comprising:
i) connecting the portable device 1 to a network terminal 2 through a universal port, wherein the portable device 1 comprises a storage module 4 identified as a storage device by the network terminal and an executable program stored in the storage module 4, and wherein the network terminal is capable of accessing Internet;
ii) executing the executable program automatically by the network terminal 2 so as to access a server 3 for dealing with a trade of digital works; and
iii) purchasing or borrowing a digital work via the network terminal 2 and downloading the digital work to the portable device 1, wherein the executable program encrypts characteristics of the portable device 1 and then transmits the encrypted characteristics to the server 3 after the digital work is clicked for downloading; and the digital work is downloaded to the portable device 1 after the encrypted characteristics are bound to the digital work.

Further, the storage module 4 comprises a read-only storage configured to store the executable program which is executable but is undeletable by the network terminal.

Further, the executable program and the digital work are stored in the storage module 4 mapped as a storage device in the network terminal.

Alternatively, the portable device comprises a plurality of storages mapped as a plurality of storage devices in the network terminal, wherein at least one storage is a read-only storage for storing the executed program, the other are readable and writable storages for storing digital works and other copyright-protected data.

Further, in the steps ii) and iii), the characteristics of the portable device transmitted to the server 3 acts as an identifier for login to the server 3.

Further, the characteristics transmitted to the server 3 by the executable program are encrypted data.

Further, the characteristics are bound to the digital work after the executable program logins the server 3 and accesses an interface for purchasing or borrowing the digital works, and the digital work is clicked for downloading; and then the digital work bound with the characteristics of the portable device 1 is downloaded and stored directly in the storage module 4 of the portable device 1.

Alternatively, the characteristics are bound to the digital work after the executable program logins the server 3 and starts up a web browser to access an interface for purchasing or borrowing the digital works, and the digital work is clicked for downloading; and then the digital work bound with the characteristics of the portable device 1 is downloaded and stored directly in the storage module 4 of the portable device 1.

Further, the transmitted characteristics of the portable device 1 is stored in and managed by the server 3; after the digital work is selected by a user, the server 3 encrypts authorization information of the digital work by using the transmitted characteristics of the portable device 1; and then the encrypted digital work is downloaded to the portable device 1.

Further, the characteristics of the portable device 1 are written into the executable program when the portable device is produced and capable of being read directly by the executable program.

Alternatively, the characteristics of the portable device 1 are read by the executable program via the port connecting the portable device 1 to the network terminal 2.

The present invention has the following effects. According to the method provided in the invention, digital works can be conveniently and safely downloaded to a portable device through a general hardware port without additional hardware and high cost. The method is also adapted for unskilled users to download copyright-protected digital works conveniently.

### BRIEF DESCRIPTION OF THE DRAWING

FIG. 1 schematically shows an implementation of the present invention;

FIG. 2 schematically shows another implementation of the present invention; and

FIG. 3 is a flowchart of the present invention.

### DETAILED DESCRIPTION

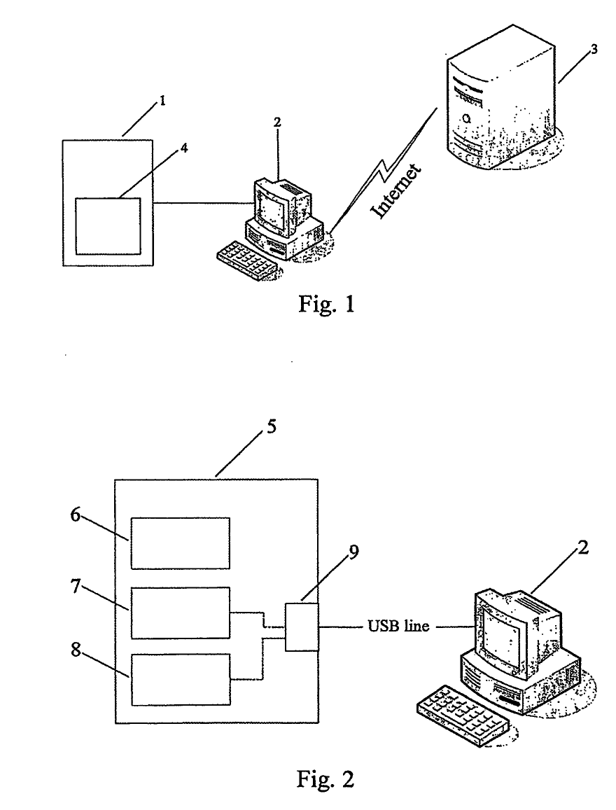

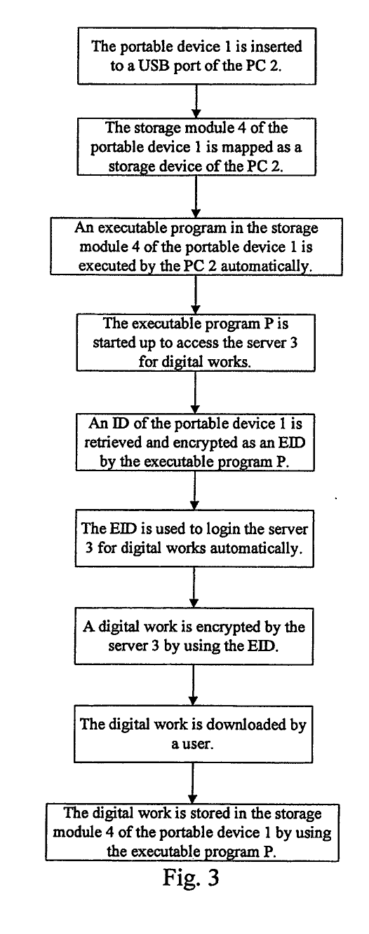

FIG. 1 shows one implementation of this invention, comprising a portable device 1, a network terminal 2 and a server 3. The portable device 1 may be an e-book reader, a PDA, a cell phone, an MP3, or the like. The network terminal 2 may be a PC with an ability of accessing Internet. The server 3 may be a server in running websites for dealing with trades in relation to digital works or other goods. The portable device is connected to the PC through a standard port such as a USB port and the PC is connected to the server via Internet. A storage module 4 is configured in the portable device for storing programs which may run in a PC, digital works to be downloaded and so on. The portable device may also comprise other components like a CPU, an operating system as well as programs executable only in the portable device.

According to the above implementation, once the portable device 1 is connected to the PC 2 through a universal port, the storage module 4 is identified as a storage device by the PC and a program P stored in the storage module will run automatically in the PC 2 so that a user can access a website in dealing with the trade of digital works via Internet. The program P is executable only in a PC so that a user can take the advantage of a PC to purchase or borrow e-works, rather than doing the same on the portable device. In view of the requirements on the protection of copyright of digital works, the program P associates the portable device 1 with the PC 2 so as to bind characteristics of the portable device 1 to the digital works to be accessed. Specifically, when a user clicks a digital work in order to purchase or borrow the work, the program P encrypts characteristics of the portable device 1 which is connected with the PC 2. The encrypted characteristics are transmitted to the server 3 for binding to the clicked digital work. In this way, the digital work bound with the encrypted characteristics of the portable device is downloaded to the portable device 1.

According to the implementation, the program P runs automatically in the PC 2. In Windows Operating System, if a USB device inserted to the PC is a storage device, the Windows may automatically execute commands in a file autorun.inf in the storage device. In this case, it is necessary to put the commands for executing the program P into the file autorun.inf. If the operating system is Windows XP and the USB device is a portable storage device, the file autorun.inf may not be executed automatically. Thus, for the Windows XP, the USB device of the present invention will be designed as another kind of storage device, other than a portable device.

Binding the characteristics of the portable device to digital works may be realized via various methods. For example, an ID number of a portable device may be used as the characteristic of the portable device, which is set in the production of the portable device. In order to bind the ID number to a digital work, the ID number of the portable device is transformed into a digital form by using a cryptology algorithm such as the message digest algorithm and then a decryption key of the transformed ID number is encrypted so that the encrypted digital work can be played or read only by this portable device. In the present invention, the binding may use, but not be limited to, any process having good compatibility, such as the process disclosed in the Chinese Patent Application No. 200410004751.7 “hardware-compatible methods for binding digital works with hardware”.

FIG. 2 shows an embodiment of the present invention. In the embodiment, the portable device may be an e-book reader 5 including a storage unit which is divided into three zones. The first storage zone is storage module M0(6) for storing programs and data for the portable device itself, including an operating system, a reading software, a program for Copyright Management, or the like. The second zone is storage module M1(7) for storing the program P. The second storage zone is preset in the production of the reader. The third zone is a readable and writable storage module M2(8) for storing the download e-books. Each reader has its own ID number as an identifier of the device, including production serial number and other characteristics.

The second and third storage modules M1 and M2 are connected to the PC via a USB port 9 of the reader and identified as two storage devices, such as an E disk (M1) and an F disk (M2), in the PC. Since the program P with a file autorun.inf is stored in the E disk, the program P can be started up and automatically run in the PC.

Specifically, the program P accesses a website in dealing with the trade of e-books. The detailed flowing for trading is realized based on the specific website. In this embodiment, the ID number or the encrypted ID number of the reader is retrieved by the program P and recorded as an EID number, Then, the program P login a website by using the EID number as a unique identifier, namely, the EID number is associated with the user management of the website so that the reader's user can login the website without inputting any user name. In this embodiment, the ID number can be retrieved by the program P via any of the following methods. The first is to retrieve the ID number via the USB port. Since the Windows Operating System needs a driver for hardware to call the port, the ID number can be retrieved by the program P only after the driver is installed. The second is writing the ID number or EID number into the program P when the reader is produced so that the program P can read the ID number or EID number directly without needing a driver.

The process of buying or borrowing an e-book can be implemented in the program P or a web browser started up by the program P.

After buying or borrowing an e-book, the user downloads the e-book. In order to protect the copyright of the e-book, the e-book in this embodiment should be encrypted in the server before being downloaded. Therefore, the server uses the EID number to encrypt key information of the e-book before the e-book is downloaded. Then, the e-book with its key information is downloaded by the program P and directly stored in the storage module M2, i.e. the F disk.

The operating system and reading software in the reader may access the storage module M2 to retrieve the EID number. Therefore, the reader may decrypt the encrypted e-book by using the retrieved EID number so as to read the e-book. Since each reader has a unique EID number, the e-book and related data cannot be read by any other reader. Therefore, the e-book is bound to the reader.

The present invention is not limited to the above embodiments. The network terminal 2 may be another kind of terminal having networking function and the PC 2 and server 3 may be integral. Other embodiments obtained by the skilled in the art according to the technical solutions in the present invention should be within the scope of the technical innovation of the present invention.

1. A method for downloading a digital work automatically bound with characteristics of a portable device, comprising:
i) connecting the portable device to a network terminal through a universal port, wherein the portable device comprises a storage module identified as a storage device by the network terminal and an executable program stored in the storage module, and wherein the network terminal is capable of accessing Internet;
ii) executing the executable program automatically by the network terminal so as to access a server for dealing with a trade of digital works; and
iii) purchasing or borrowing a digital work via the network terminal and downloading the digital work to the portable device wherein the executable program encrypts characteristics of the portable device and then transmits the encrypted characteristics to the server after the digital work is clicked for downloading; and the digital work is downloaded to the portable device after the encrypted characteristics are bound to the digital work.

2. The method of claim 1, wherein the storage module comprises a read-only storage configured to store the executable program which is executable but is undeletable by the network terminal.

3. The method of claim 2, wherein the executable program and the digital work are stored in the storage module mapped as a storage device in the network terminal.

4. The method of claim 2, wherein the portable device comprises a plurality of storages mapped as a plurality of storage devices in the network terminal, wherein at least one storage is a read-only storage for storing the executed program, the other are readable and writable storages for storing digital works and other copyright-protected data.

5. The method of claim 1, wherein, in the steps ii) and iii), the characteristics of the portable device transmitted to the server acts as an identifier for login to the server.

6. The method of claim 5, wherein the characteristics transmitted to the server by the executable program are encrypted data.

7. The method of claim 5, wherein the characteristics are bound to the digital work after the executable program logins the server and accesses an interface for purchasing or borrowing the digital works, and the digital work is clicked for downloading; and then the digital work bound with the characteristics of the portable device is downloaded and stored directly in the storage module of the portable device.

8. The method of claim 5, wherein the characteristics are bound to the digital work after the executable program logins the server and starts up a web browser to access an interface for purchasing or borrowing the digital works, and the digital work is clicked for downloading; and then the digital work bound with the characteristics of the portable device is downloaded and stored directly in the storage module of the portable device.

9. The method of claim 6, wherein the transmitted characteristics of the portable device is stored in and managed by the server; after the digital work is selected by a user, the server encrypts authorization information of the digital work by using the transmitted characteristics of the portable device; and then the encrypted digital work is downloaded to the portable device.

10. The method of claim 1, wherein the characteristics of the portable device are written into the executable program when the portable device is produced and capable of being read directly by the executable program, or the characteristics of the portable device are read by the executable program via the port connecting the portable device to the network terminal.
